(19) United States
(12) Patent Application Publication
(10) Pub. No.: US 2025/0028104 A1
(43) Pub. Date: Jan. 23, 2025

(54) DIRECT-WRITE LASER-ASSISTED ALTERING OF METASURFACES

(71) Applicant: University of Rochester, Rochester, NY (US)

(72) Inventors: Marcela Mireles, Rochester, NY (US); Brittany Hoffman, Rochester, NY (US); Stavros Demos, Rochester, NY (US)

(21) Appl. No.: 18/778,855

(22) Filed: Jul. 19, 2024

Related U.S. Application Data
(60) Provisional application No. 63/514,561, filed on Jul. 19, 2023.

(51) Int. Cl. G02B 5/30; B82Y 20/00; B82Y 40/00; G02B 1/00

(52) U.S. Cl. CPC G02B 5/3008; B82Y 20/00; B82Y 40/00; G02B 1/005; G02B 2207/101

(57) ABSTRACT

This disclosure provides a method for altering a nanostructured surface of an optic, including placing the optic under vacuum and exposing an area of the nanostructured surface to an irradiation source for a predetermined time and impinging energy such that the irradiation changes a nanostructure of the surface in the exposed area thereby altering an optical property. Further, this disclosure provides a system for altering a nanostructured surface of an optic, including a vacuum chamber for placing the optic under vacuum, an irradiation source configured to expose at least a portion of an area of the nanostructured surface with irradiation, and a processor in electronic communication with the irradiation source and configured to energize the irradiation source for a predetermined time and irradiation energy so as to change a nanostructure of the surface in the exposed area thereby altering an optical property.

### CROSS-REFERENCE TO RELATED APPLICATIONS

This application claims priority to U.S. Provisional Application No. 63/514,561 filed on Jul. 19, 2023, now pending, the disclosure of which is incorporated herein by reference.

### STATEMENT REGARDING FEDERALLY SPONSORED RESEARCH

This invention was made with government support under DE-NA0003856 awarded by the Department of Energy. The government has certain rights in the invention.

### FIELD OF THE DISCLOSURE

The present disclosure relates to optics, and more specifically to altering (for example, patterning) optical properties of an optic.

### BACKGROUND OF THE DISCLOSURE

Birefringence is an important optical property, which arises from direction dependent refractive index. Although first discovered in crystalline solids, birefringence is not a property exclusive of crystals. A large variety of materials can exhibit form birefringence, direction-dependent refractive index due to their organized microstructure. Among these nanostructured materials, coatings fabricated by glancing angle deposition (GLAD) are an interesting alternative to traditional materials that possess bulk birefringence properties. Low-loss transmissive GLAD waveplates made from oxides such as SiO₂ and MgO have been recently demonstrated. A key advantage of these materials is their scalability to large size optical elements with a relatively low fabrication cost and high surface quality uniformity resulting in top optical performance.

Polarization control optics, referred to as waveplates, have long been used in optical systems to enable altering the polarization state of the light traveling through them. These essential optics are typically based on the birefringent properties of bulk materials which remain homogenous as a function of position. However, spatial control of optical birefringence has become a highly desirable and increasingly important capability to enable a new generation of optics for controlling light propagation and its properties. The latter requires the development of waveplates showcasing spatial variation of their birefringence. For example, all-silica GLAD waveplates have been fabricated as stripes on a fused silica substrate, patterned by photolithography to provide spatial variation of the retardance. However, a methodology enabling the realization of complex patterns has not yet been achieved. Current generation polarization control optics that can provide spatially tailored polarization control are based on liquid crystals devices, which are arguably complex and not suitable for high power laser applications in the ultraviolet spectral region.

Development of techniques to spatially tailor the birefringence in GLAD waveplates based on large bandgap dielectric materials can address the low performance characteristics of liquid crystal materials enabling the fabrication of optics for complex control of polarization in high power lasers operating in the ultraviolet to near infrared spectral region. Such advanced optics can be utilized for improved beam shaping, distributed phase rotators, light valves, apodizers, and beam spot blockers and other applications. When utilized in inertial confinement high power laser systems, these advanced optics have the potential of enabling new ways to deliver laser power onto a target more effectively to help minimize adverse laser plasma interactions.

### BRIEF SUMMARY OF THE DISCLOSURE

The present disclosure provides methods and systems for direct tailored modification of the optical property of a surface of an optical component. For example, the present techniques may be used to modify the birefringence inherent in GLAD coatings using the energy of a laser. This leads to the ability to achieve spatial modification and control of the birefringence of an optic, fabricated using the principles disclosed herein. The present disclosure enables spatial control of the polarization within the spatial profile of a laser beam propagating through this optic. Laser irradiation assisted in localized heating and/or melting of GLAD coatings, subsequently modifying the microstructure and altering the local retardance. The presently disclosed process is performed under high vacuum to avoid trapping air within the coating. The change in birefringence was evidenced through in-line tracking with a polarization sensitive camera as well as off-line traditional Mueller matrix polarimetry. The change in microstructure was observed and analyzed through electron microscopy. SiO₂ has been the material of choice in near ultraviolet high-power laser system. Thus, the present disclosure is described with reference to SiO₂ GLAD coatings, but the present methods may be applied to other materials, coatings, and surfaces (e.g., metasurfaces), and such are considered within the scope of the disclosure.

In an example, the present technique may be used to locally modify the birefringence of waveplates fabricated by glancing angle deposition. The method employs localized melting of the anisotropic microstructure/nanostructure in a vacuum environment, which in turn alters the local birefringence. The process is performed under high vacuum to avoid trapping air within the melt zone. The direct-write method presented here can be readily utilized for coatings exhibiting form-birefringence of virtually any chemical composition, size, and format.

The disclosed method and system may be applied broadly to applications related to optical components that provide control of an optical property. Optical properties include, but are not limited to, birefringence, optical transmission, optical scattering, introduction of phase difference, and others. Furthermore, the present techniques may be used with different types of surfaces, including coatings or surfaces formed from the underlying material, which affect one or more optical properties, such as, for example, metasurfaces (e.g., including nanostructures that provide control of an optical property of light propagating through the material) and porous materials. These are non-limiting examples, and other optical properties and/or surface structures may be used.

### DESCRIPTION OF THE DRAWINGS

For a fuller understanding of the nature and objects of the disclosure, reference should be made to the following detailed description taken in conjunction with the accompanying drawings.

FIG. 1. (a) A diagram of a system according to an embodiment of the present disclosure and used for experimentation; and (b) example images taken with an in-line polarization sensitive camera allowing for birefringence tracking during irradiation.

FIG. 2. Schematic description of an exemplary coating used in an embodiment of the present disclosure overlaid on scanning electron micrographs illustrating the advantages of processing in a vacuum environment to avoid trapping air within the coating. Cross-section images of processed coatings were taken at the center of irradiation.

FIG. 3. Modified microstructure resulting from ramping up the laser power to 27 Watts as shown from cross-section scanning electron micrographs. The images from left to right are representative of the microstructure when moving toward the center of the spot.

FIG. 4. Effect of anisotropic microstructure on laser-assisted melting. (a) Modified retardance resulting from ramping up the laser power to 28 W, the size of the irradiated area has been marked with a circle of 2.7 mm in diameter, corresponding to the pinhole used in the system. (b) Top-view scanning electron micrograph taken from a single layer coating before and after irradiation showing increased void fraction in a direction perpendicular to the fast axis.

FIG. 5. Modified retardance upon varying the irradiation conditions: (a) effect of increasing laser power while keeping irradiation time constant at 5 seconds: (b) effect of increasing the irradiation time while keeping the laser power constant at 27 W.

FIG. 6. Direct-write pattern on an all-silica GLAD coating: (a) retardance map; and (b) as seen through crossed polarizers.

FIG. 7. A chart depicting a method according to another embodiment of the present disclosure.

FIG. 8. A micrograph of a portion of an example metasurface structured as a grating.

FIG. 9. A micrograph showing a cross-sectional view of several nanostructures making up a portion of a grating.

FIG. 10. A diagram depicting nanostructures of another example of a metasurface.

FIG. 11. A diagram depicting nanostructures of another example of a metasurface.

FIG. 12. A diagram depicting nanostructures of another example of a metasurface.

FIG. 13. A diagram depicting nanostructures of another example of a metasurface.

### DETAILED DESCRIPTION OF THE DISCLOSURE

The present disclosure provides a methodology affording spatial control over an optical property inherent to a surface of a substrate (including, for example, a coating of the substrate). In a non-limiting example, the presently disclosed techniques may provide spatial control over the retardance of birefringent waveplates by modifying the microstructure of birefringent coatings, such as, for example, coatings fabricated by glancing angle deposition (GLAD). The presently disclosed technique is performed in a vacuum environment to avoid the formation of large pores upon localized melting of the coating, and a laser (e.g., a CO₂ laser) is used to locally modify an area of the coating (e.g., along a predesign pattern). As discussed below, experimental work has demonstrated laser power to be the dominant processing parameter. The elicited change in microstructure modifies the form birefringence with the concomitant effect of controlling the output polarization beam profile of a laser beam propagating through the processed optic. The work reported here is paramount because it opens new avenues for the experimental realization of optics for complex polarization control which require spatial control of birefringence. An important application of these optics is their use in high-power laser systems to achieve peak performance in order to effectively deliver laser power onto a target.

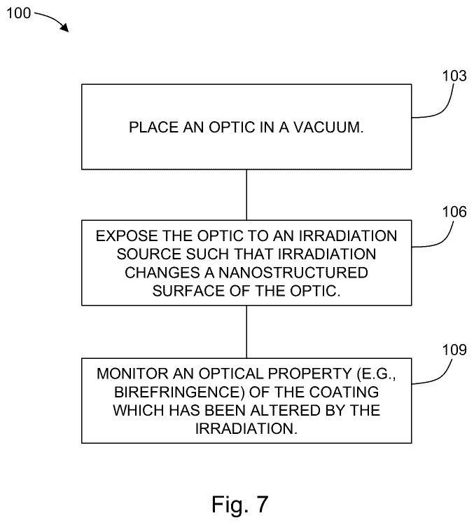

With reference to FIG. 7, the present disclosure may be embodied as a method 100 for altering (e.g., patterning) an optical property of an optic. For example, the method 100 may be used to alter a nanostructured surface of an optic, such as, for example, a coating of an optic. The optical property may be, for example, birefringence. In other embodiments, the optical property may be spectrally dependent reflectance or transmittance, nonlinear refractive index modulation, and other functional properties that may be based on a nanostructured surface. In a particular, non-limiting example, the optic may be a polarization controlling optic, such as, for example, a waveplate. The optical property may be provided by a coating of the optic, such as, for example, a nanostructured coating. For example, a coating may have at least one layer fabricated by glancing angle deposition (GLAD). Other types of coatings may be used where the coating has a nanostructure which provides optical functionality (e.g., birefringence). In some examples, a coating includes a plurality of layers, such as, for example, twenty or more layers. In a typical birefringent GLAD coating, the thickness of the coating is on the order of microns (e.g., 1-5 μm), but the present technique may be used for thinner or thicker coatings.

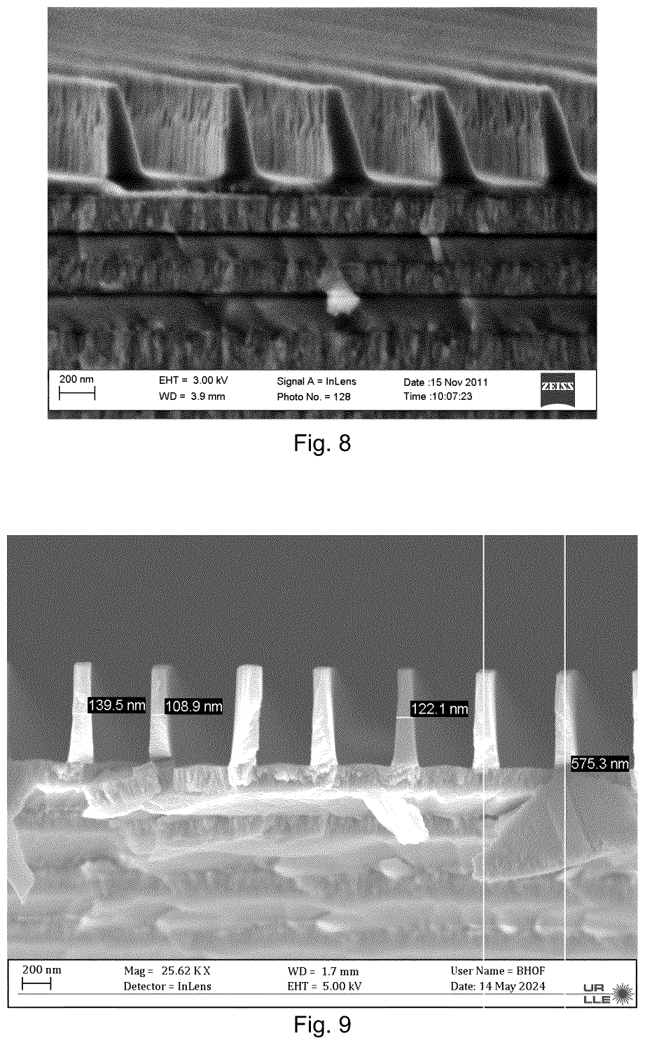

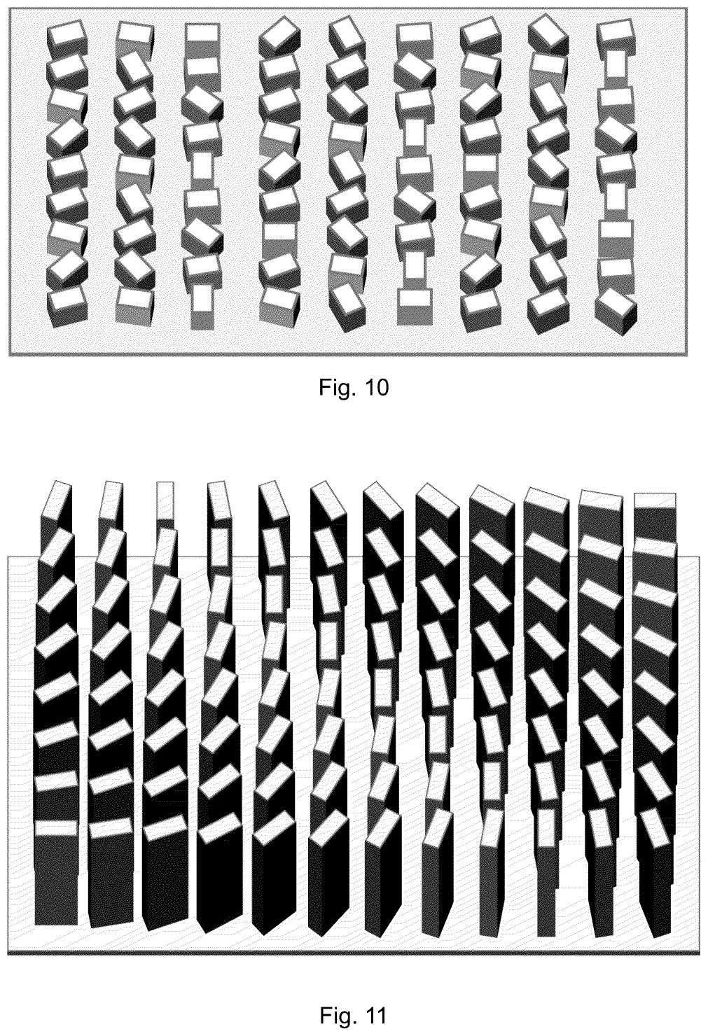

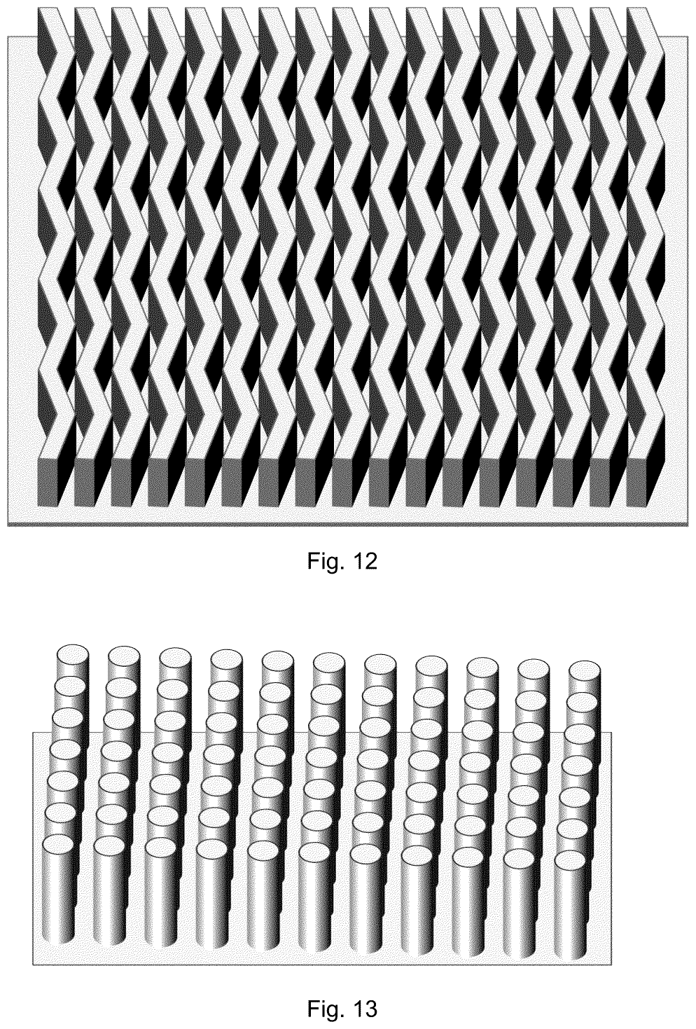

The nanostructured surface may be, for example, structures formed on a surface of the material or structures within the surface/material. FIGS. 8 and 9 show nanostructures which are part of a nanostructured surface forming a grating on a surface of an optic. FIGS. 10 and 11 depict nanostructured surfaces having generally cuboid structures on the surfaces. FIG. 12 depicts a zig-zag formation in a nanostructured surface. FIG. 13 depicts a nanostructured surface having cylindrical structures. In some embodiments, the optical property results from a characteristic of the optic material itself. For example, the material may be porous at or near the surface (or throughout the material). The term nanostructured surface is used herein as a broad term which may involve a coated surface, nanostructures formed on a surface of the substrate, a characteristic (e.g., porosity, etc.) of the substrate material itself, or other metasurfaces.

The method 100 includes placing 103 the optic under a vacuum (e.g., within a vacuum environment). In various embodiments, the vacuum may have a pressure less than or equal to 2.5×10⁻² Torr. In various embodiments, the vacuum may have a pressure less than or equal to 2.5×10⁻⁵ Torr. An area of a nanostructured surface of the optic is exposed 106 to an irradiation source for a predetermined time. In this way, energy impinges on the exposed area such that irradiation from the irradiation source changes the nanostructured surface in the exposed area, thereby altering the optical property. For example, the surface of the optic may be a birefringent coating and changing the nanostructure of the coating alters its retardance—e.g., reducing its retardance. In a more particular example, such a birefringent coating may be a GLAD coating. The GLAD coating may be made from any material that can be fabricated using the glancing-angle technique to produce an optically functional coating (e.g., birefringence). For example, the coating may be a dielectric, such as nitrides, fluorides, or an oxide (for example, silicon dioxide (SiO₂), magnesium oxide (MgO), niobium oxide, hafnium oxide, aluminum oxide, titanium oxide, etc.)

The irradiation may induce local melting in the coating, thereby changing the nanostructure to alter an optical property. By changing the nanostructure, it is intended that the chemical elemental composition of the material is not modified (e.g., silicon and oxygen concentrations are largely unchanged), and the nanostructure changes in its morphology (e.g., by local heating in a vacuum environment that may include partial or complete melting). The irradiation source may be any suitable source able to deliver energy in a controlled fashion, such as, for example, a light source, an electromagnetic wave source, a laser source, a microwave source, an electron beam, a particle beam, and/or an ion beam, etc. For example, the irradiation source may be a laser. The laser irradiation may be provided using a laser operating at a wavelength that is highly absorptive by the nanostructured surface, for example, a CO₂ laser for a SiO₂ based material that is demonstrated in the examples presented in this disclosure. By highly absorptive, it is intended that the laser is capable of inducing a change in the nanostructure of the material. CO₂ lasers are known to be effective to induce heating in silica-based materials. CO₂ or other lasers may be used for silica-based or other materials. The laser type may be selected such that the wavelength of the emitted beam has a propagation depth in the material which is on the same order as the thickness of the nanostructured surface (i.e., according to the absorption spectrum of the material). For example, in embodiments having a coating, the penetration depth may be the same as the coating thickness. In some embodiments, the penetration depth may be within 5% of the coating thickness. The irradiation (e.g., laser irradiation) may have a power density (i.e., irradiance) of greater than 300, 400, 500, or 600 W/cm² (at the nanostructured surface), but the power density depends mainly on the melting temperature and thermal conductivity of the surface material. For example, the irradiation may have a power density of between 300 and 600 W/cm² (at the nanostructured surface). The irradiation may have any spot size suitable to the particular application. For example, the spot size may be selected so as to be small enough to enable patterning of a desired feature size, while also large enough to minimize the scanning required to expose the desired area of the optic.

In some embodiments, the nanostructured surface is a porous surface-such as, for example, a result of a porosity of the material. In such embodiments, the irradiation source may heat the material thereby removing the porosity as the material solidifies under vacuum. Such a porous material may be, for example, a nano-porous or macro-porous glass, a ceramic material, a dielectric foam, and the like.

The nanostructured surface may be exposed to the laser irradiation for a predetermined time of greater than 0.5, 1, 5, 10, 15, 20, 25, 30, 35, or 40 seconds. In some embodiments, the predetermined time is between 0.5 and 40 seconds, inclusive. In some embodiments, the predetermined time is between 10 and 40 seconds, inclusive. In some embodiments, a spot diameter of the irradiation is smaller than the area of the nanostructured surface to be exposed to the irradiation. In such embodiments, the irradiation is moved to expose the area (the entire area to be exposed). For example, the irradiation can be scanned (e.g., rastered, etc.) over the area. In such embodiments, the predetermined time may be the exposure time of each portion of the area to be exposed—i.e., the total time to expose the entire area may be greater than the predetermined time. In some embodiments, the predetermined exposure time of each portion of the area to be exposed can vary during exposure to introduce varying degrees of modification—i.e., modulate the optical property of portions of the optic to varying amounts.

The method 100 may further include on-line monitoring 109 the optical property of the nanostructured surface. For example, where the optical property is birefringence, the polarization of the nanostructured surface may be monitored 109 (e.g., using a polarization sensitive camera, a Mueller polarimeter, etc.) For example, the optical property may be on-line monitored during processing of the optic.

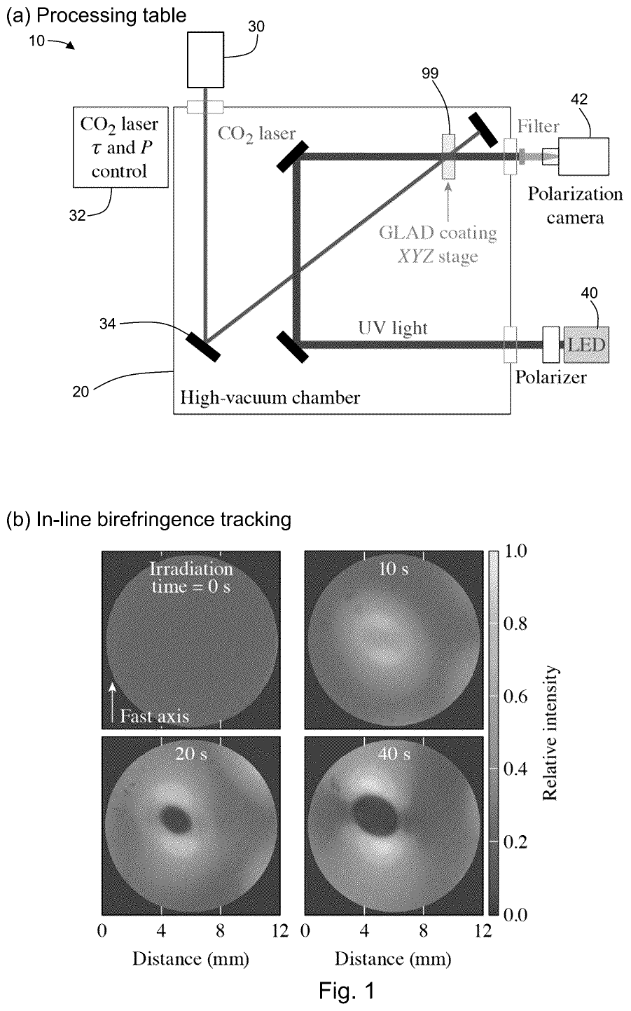

With reference to FIG. 1(a), in another aspect, the present disclosure may be embodied as a system 10 for altering a nanostructured surface of an optic 99. For example, the system 10 may be used to create a pattern of form birefringence of the nanostructured surface. The optic may be, for example, a waveplate. In a more particular example, the optic may have a coating having at least one layer fabricated by glancing angle deposition (GLAD). Other types of coatings may be used where the coating has a nanostructure which provides optical functionality (e.g., birefringence). In some examples, the coating includes a plurality of layers, such as, for example, twenty or more layers. In a typical birefringent GLAD coating, the thickness of the coating is on the order of microns (e.g., 1-5 μm), but the present technique may be used for thinner or thicker coatings. The system 10 includes a vacuum chamber 20 configured to hold an optic 99 and for placing the optic under vacuum. The vacuum chamber 20 may be configured to apply a vacuum of less than or equal to 2.5×10⁻⁵ Torr.

An irradiation source 30 is configured to expose at least a portion of an area of the coating with irradiation. A processor 32 is in electronic communication with the irradiation source 30. The processor 32 is configured to energize the irradiation source 30 for a predetermined time and power. In this way, the irradiation changes the nanostructure of the surface of the optic, thereby altering an optical property. For example, the irradiation may be configured to change the nanostructure of a birefringent coating to alter its retardance e.g., reducing the retardance. In a more particular example, the irradiation may be configured to change the birefringent nanostructure of a GLAD coating. The GLAD coating may be made from any material that can be used to form a coating using the glancing-angle technique to form an optically functional coating (e.g., birefringence). For example, the coating may be a dielectric, such as a nitride, a fluoride, or an oxide (for example, silicon dioxide (SiO₂), magnesium oxide (MgO), niobium oxide, hafnium oxide, aluminum oxide, titanium oxide, etc.)

The irradiation source 30 may be any suitable type, such as, for example, a light source, an electron beam, a particle beam, and/or an ion beam, etc. For example, the irradiation source may be a laser, such as, for example, a CO₂ laser. CO₂ lasers are known to be effective in inducing heating in silica-based materials. CO₂ or other lasers may be used for silica-based materials or other materials. The irradiation source may be selected such that the emitted beam has a propagation depth in the material (e.g., optical substrate, coating, etc.) which is on the same order as the thickness of the nanostructured surface. For example, a laser source may be selected to have a wavelength with a propagation depth in the material which is on the same order as the thickness of the nanostructured surface (i.e., according to the absorption spectrum of the material). The irradiation source may provide irradiation having a power density (i.e., irradiance) of greater than 300, 400, 500, or 600 W/cm² (at the nanostructured surface). For example, the irradiation may have a power density of between 300 and 600 W/cm² (at the nanostructured surface). The irradiation may have any spot size suitable to the particular application. For example, the spot size may be selected so as to be small enough to enable patterning of a desired feature size, while also large enough to minimize the scanning required to expose the desired area of the surface of the optic.

The processor may be configured to energize the irradiation source for a predetermined time of greater than 5, 10, 15, 20, 25, 30, 35, or 40 seconds. In some embodiments, the predetermined time is between 0.5 and 40 seconds, inclusive. In some embodiments, the predetermined time is between 10 and 40 seconds, inclusive. In some embodiments, the irradiation source may be configured to have a spot diameter that is smaller than the area of the nanostructured surface to be exposed to the irradiation. In such embodiments, the system 10 may further include a scanner 34 for moving the irradiation spot on the sample 99 in at least one dimension. The scanner 34 is in electronic communication with the processor 32 and the processor 32 is configured to cause the scanner 34 to move the irradiation spot so as to expose the area of the nanostructured surface (the pre-determined area to be modified). The scanner may be or may include a mirror and/or a stage. In this way, the irradiation spot can be scanned (e.g., rastered, etc.) over the area. In such embodiments, the predetermined time may be the exposure time of each portion of the area to be exposed—i.e., the total time to expose the entire area may be greater than the predetermined time. In other embodiments, the predetermined exposure time of each portion of the area to be exposed can vary between spots to introduce varying degrees of modification—i.e., modulate the optical property of portions of the optic 99 to varying amounts.

In some embodiments, the system 10 may further include a light source 40 and a detector 42 for imaging the altered optical property of the nanostructured surface. For example, in the embodiment depicted in FIG. 1(a), the system includes a polarized light source 40 and polarization analyzer 42 to map the polarization of the optic in real time. In this way, the retardance of the nanostructured surface can be monitored by the system during processing. In some embodiments, the processor may be configured via a feedback loop to monitor and modify accordingly the predetermined time and/or a power of the irradiation source based on a signal received from the detector (e.g., the polarization analyzer).

The present disclosure is further illustrated using experimental embodiments described below. The experimental embodiments are intended to be non-limiting.

### Materials and Methods

### Coating Fabrication

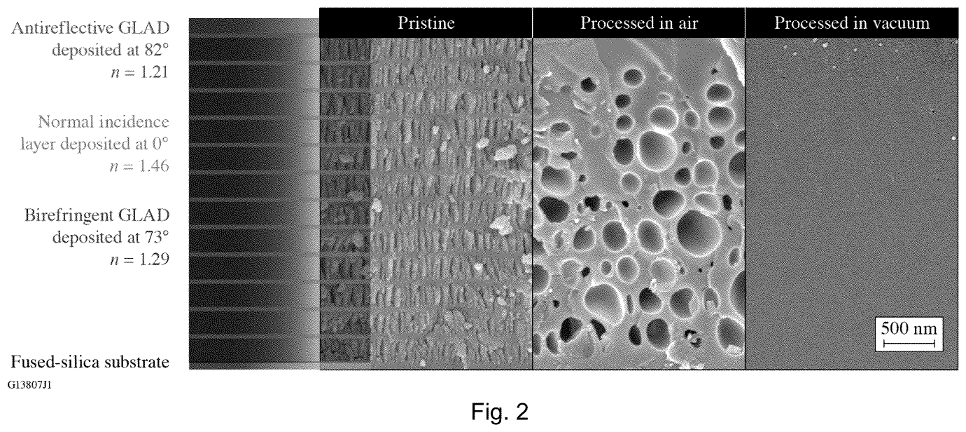

All-silica coatings were fabricated through glancing angle serial bideposition following the methodology reported by this group elsewhere. In short, clean fused silica substrates were mounted onto a custom Angstrom Engineering GLAD stage inside an e-beam deposition chamber. The chamber was evacuated overnight and heated to 25° C. with the use of quartz lamps. The base pressure was better than 1×10⁻⁶ Torr and deposition was carried out without the addition of reactive gases. The deposition rate was controlled to 9 Å/s using feedback from a quartz crystal microbalance. FIG. 2 shows a schematic representation of the cross-section, annotated with the deposition angles as well as the measured effective refractive indices.

The number and thickness of birefringent layers determines the overall retardance of the waveplate. The coating used in the present example embodiment was made up of 24 alternating layers deposited at 0° (normal incidence) and 73°: terminated with an antireflection layer deposited at 82°. This quarter-waveplate stack was design to be used for the ultraviolet (351 nm) in a vacuum environment and has documented low loss, high laser-induced damage threshold (LIDT), and wide design bandwidth.

### Laser Assisted Processing

The processing experimental system included five main components: (1) a CO₂ laser with exposure time and power control, (2) a collimated light-emitting diode (LED) source equipped with a polarizer, (3) a motorized stage with XYZ control, (4) a polarization sensitive camera for in-line retardance change tracking, and (5) a vacuum chamber to allow for processing under vacuum at a pressure <2.5×10⁻⁵ Torr. FIG. 1(a) presents a schematic representation of the experimental system. The CO₂ laser used had a wavelength of 10.6 μm (SYNRAD, Firestar ti-series) which produced a circular beam with linear polarization. Other beam shapes may be utilized. The laser beam was directed through a pinhole with a 2.7 mm diameter aperture before reaching the samples. A fiber-coupled LED operating at a wavelength of 365 nm complemented by a wire grid linear polarizer was used for back illumination of the sample to support imaging of the modification of the retardance in real time using a polarization sensitive (PS) camera. The image at the sample plane generated under illumination with the polarized LED light propagating through the sample was captured by the PS camera (Thorlabs, CS505MUP1) equipped with a suitable lens and after passing thought a 400 nm short pass filter (UG11) to suppress thermal emission during laser irradiation. The PS camera is equipped with a polarized sensor (5.0 MP, monochrome CMOS) with wire grid polarizer array comprised of a repeating pattern of polarizers (0°, 45°, −45°, and 90° transmission axes) placed on-chip to form and image array of four pixels blocks constituting each calculation unit. The PS camera enabled in-line tracking of the changes in the propagated 365 nm LED light polarization state arising from modification of the birefringence of the coating during processing. An example of the in-line birefringence tracking is shown in FIG. 1(b) from a coating irradiated for up to 40 seconds with its fast axis placed at 45°. The data presented shows the vertical polarization response only: in these images a value of zero denotes complete removal of birefringence. The on-line imaging capability facilitated rapid testing at various exposure conditions toward development of an efficient processing protocol.

Experiments were initially performed in ambient air but the results indicated it is advantageous to carry out the process in a vacuum environment to avoid trapping air into voids within the coating. This is demonstrated by the cross-section scanning electron micrographs taken from two coatings processed either in air or in vacuum shown in FIG. 2. The micrographs were taken from the center of the irradiated areas and demonstrate the significant difference in morphology. The coating processed in air contains numerous voids which contribute to excessive light scattering. The coating processed in vacuum resulted in a full density film virtually indistinguishable from the substrate.

### Characterization

The change in birefringence was further characterized after exposure using the polarization sensitive camera discussed in the previous section. The camera is able to probe the first three Stokes parameters. In addition, Mueller matrix polarimetry was carried out with an Exicor 450XT from Hinds Instruments capable of measuring the full Muller matrix at a wavelength of 355 nm. Maps were taken with a beam size of 1 mm in diameter scanned across the area of interest along a 0.5 mm square grid. Finally, the microstructure of the film as a function of the position was evaluated through scanning electron microcopy for which the samples were coated with a thin metallic layer to avoid charging effects.

### Results

### Laser-Assisted Modification of Form Birefringence

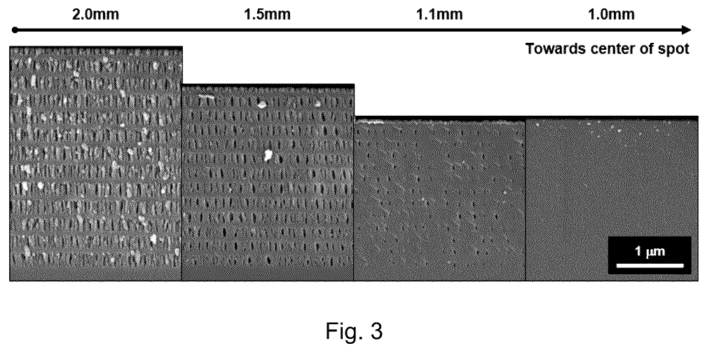

An example experiment involved irradiation of a sample at a single spot performed by ramping the laser power up to 27 W. The resulting microstructure at different distances from the center of the irradiated spot was imaged using cross-section SEM micrographs and the observations are summarized in FIG. 3. The cross-section SEM micrographs presented evidence the gradual loss of microstructure as function of position relative to the center laser beam arising from the different temperature reached in each location during irradiation. Specifically, a lack of features is observed at the center of the spot where the coating is indistinguishable from the substrate. We attribute this behavior to the complete melting of the GLAD structure that led to the transformation of the coating material to a state that is practically identical to that of the substrate. A continuous change of the GLAD nanostructure morphology is observed with increasing distance from the center of the irradiated spot. It is noteworthy that this change in microstructure due to heating and/or melting does not occur layer by layer but over the entire stack of layers. The latter is indicated by the identifiable presence of the 25 layers that have the same structure for a fixed distance from the center of the spot. This indicates that the temperature difference between the top and bottom GLAD layers is sufficiently the same. The microstructure has almost vanished close to the center of the irradiated spot. A 30% thickness decrease was estimated between the panels a and c in FIG. 3. The difference in thickness is due to laser-induced melting leading to porosity loss, producing a coating with a density similar to that of bulk silica.

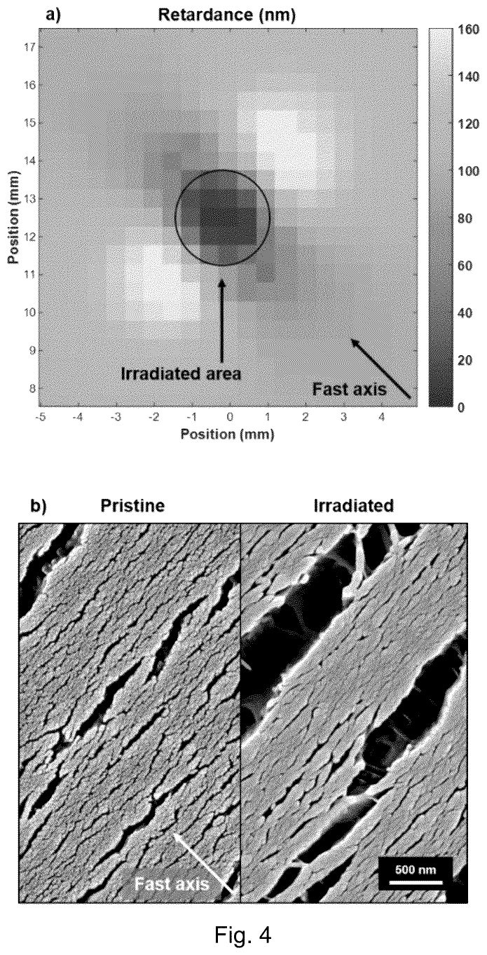

Form birefringence arises from anisotropy in the microstructure which is composed of vertical columns surrounded by a void fraction preferentially localized in a direction perpendicular to the fast axis. FIG. 4(a) corresponds to the retardance map representative of the characteristic pattern arising from localized melting. The pattern includes: (1) close to zero retardance in the middle, (2) decreased retardance in a direction parallel to the fast axis, and (3) increased retardance in a direction perpendicular to the fast axis. The area of increased retardance indicates that the void fraction increases preferentially in that direction (perpendicular to the fast axis) which has the concomitant effect of increasing the form birefringence. FIG. 4(b) provides top-view scanning electron micrographs taken from a representative coating demonstrating the anisotropic melting of the coating in the area outside of the center spot. Overall, the retardance change outside the central irradiated area resulting from material redistribution is direction-dependent and defined by the microstructure.

### Effect of Laser Irradiation Conditions

Two specific tests conducted as part of this work are discussed next to illustrate the effect of laser irradiation on the modified retardance of the coating. First, the laser power was varied to a setpoint in the range from 20.5 to 33 W (358 to 576 W/cm² estimated value at the sample by considering the size of the pinhole used, 2.7 mm in diameter) while maintaining a constant 5 s irradiation time at the desired setpoint. For this experiment, the power was increased at a rate of ˜1 W/s to reach the prescribed setpoint. In a second test the laser power, without a ramp, was set constant at 27 W while the irradiation time was increased from 10 to 40 s. Similar results regarding the modification of the GLAD coating were obtained, indicating that the laser-assisted processing can be controlled by either power or time.

### Increasing Laser Power

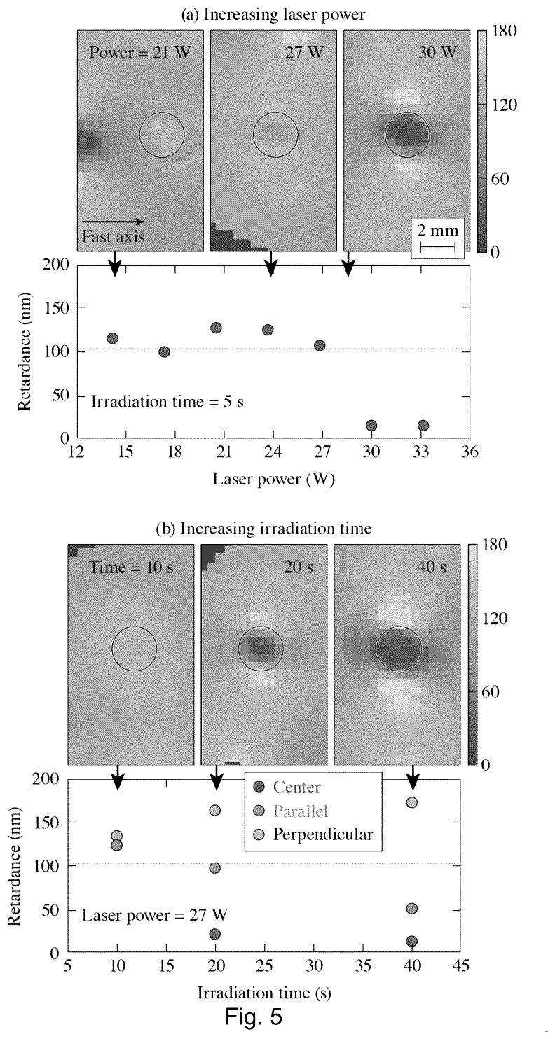

In FIG. 5(a) the average retardance at the center of irradiation spot has been plotted as function of laser power and selected retardance maps have been included at the top. Overall, an initial retardance increase at the lower power settings tested was observed before a steady decrease was recorded at higher power. In detail, an initial retardance increase to 114.5 nm resulted from irradiating at 20.5 W while a decrease to <14.1 nm was obtained for laser power>30 W. The initial 23.4% retardance increase can be attributed to densification of the GLAD columnar microstructure which leads to increased void fraction and improved form birefringence. However, irradiating at laser power>27 W results in rapid change in retardance with 86% decrease due to localized melting resulting in the loss of microstructure and form birefringence.

### Increasing Irradiation Time

Similar results were obtained when increasing irradiation time at a constant laser power of 27 W. The results obtained from this test are presented in FIG. 5(b) where the retardance at the center as well as parallel and perpendicular to the fast axis have been plotted, retardance maps have been included at the top. The center and parallel retardance follow a similar trend toward zero, while the perpendicular retardance increases. An average maximum retardance value of 182.6 nm was obtained (perpendicular to fast axis) for a 40 s irradiation time. The retardance pattern observed is dictated by the microstructure as explained above.

### Direct-Write Pattern

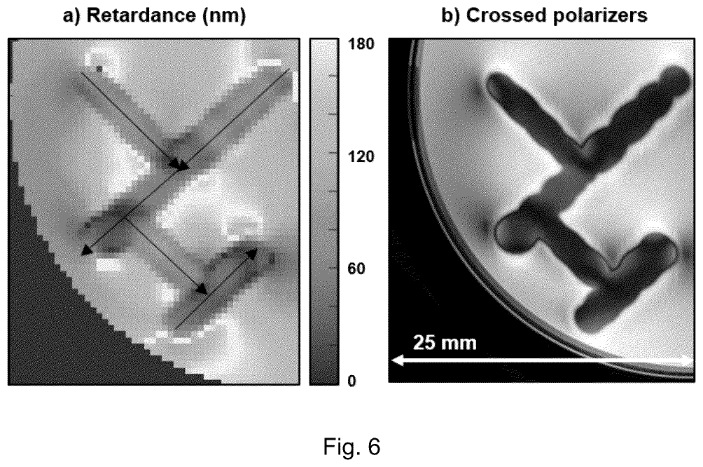

To demonstrate the potential of this method to generate direct writing on a GLAD coating, a simple pattern was generated by moving the stage at a constant speed of 0.2 mm/s while irradiating the sample with the laser power set to 30 W. Under these conditions the retardance pattern shown in FIG. 6(a) was produced in five connecting segments which have been indicated on the map with arrows pointing in the scanning direction. FIG. 6(b) shows the coating as imaged through crossed polarizers. As seen in the photograph, the pattern edges are not straight, this is due to instabilities in the laser energy. Further optimization of the irradiation conditions will improve the pattern produced. Nevertheless, the pattern in this non-limiting proof-of-concept demonstrates the usefulness of the method introduced in this work to spatially control the polarization properties of optical coatings with form birefringence.

Although the present disclosure has been described with respect to one or more particular embodiments, it will be understood that other embodiments of the present disclosure may be made without departing from the spirit and scope of the present disclosure.

What is claimed is:

1. A method for altering an optical property of a nanostructured surface of an optic, comprising:
placing the optic under vacuum; and
exposing an area of the nanostructured surface of the optic to an irradiation source for a predetermined time and impinging energy such that irradiation from the irradiation source changes the nanostructured surface in the exposed area thereby altering the optical property.

2. The method of claim 1, wherein the optical property is birefringence and the irradiation changes the nanostructured surface thereby altering retardance.

3. The method of claim 2, wherein the retardance is reduced by the irradiation.

4. The method of claim 1, wherein the nanostructured surface is a birefringent coating.

5. The method of claim 4, wherein the birefringent coating is fabricated by a glancing angle deposition (GLAD).

6. The method of claim 5, wherein the birefringent coating is a dielectric.

7. The method of claim 1, wherein the irradiation source is one or more of a light source, an electron beam, a particle beam, and an ion beam.

8. The method of claim 1, wherein the nanostructured surface is a porous surface, a grating, or other metasurface.

9. The method of claim 1, wherein the irradiation source is configured to penetrate into the material undergoing processing to a depth which is the same as a thickness of the nanostructured surface.

10. The method of claim 1, wherein the vacuum is less than or equal to 2.5×10⁻² Torr.

11. The method of claim 1, wherein the exposed area of the nanostructured surface is changed by local heating.

12. The method of claim 1, wherein the nanostructured surface is a porous surface and the exposed area of the nanostructured surface is changed by local heating to remove porosity.

13. The method of claim 1, wherein a spot diameter of the irradiation is smaller than the exposed area and wherein the irradiation is moved to expose the area.

14. The method of claim 1, further comprising on-line monitoring the optical property of the coating during irradiation exposure.

15. The method of claim 14, wherein the polarization of the nanostructured surface is monitored using a polarization sensitive camera, a Mueller polarimeter, or both.

16. A system for altering a nanostructured surface of an optic, comprising:
a vacuum chamber for placing the optic under vacuum;
an irradiation source configured to expose at least a portion of an area of the nanostructured surface with irradiation;
a processor in electronic communication with the irradiation source and configured to direct the irradiation for a predetermined time and irradiation energy such that the irradiation changes the nanostructured surface in the exposed area thereby altering an optical property.

17. The system of claim 16, further comprising a scanner for moving the irradiation across the nanostructured surface of the optic in at least two dimensions, wherein the scanner is in electronic communication with the processor, and wherein the processor is further configured to cause the scanner to move the irradiation to expose the area of the nanostructured surface.

18. The system of claim 16, wherein the irradiation source is configured to change the nanostructure of a birefringent nanostructured surface thereby altering a retardance of the nanostructured surface.

19. The system of claim 16, wherein the irradiation source is a laser having an emission wavelength selected to penetrate into the optic to a depth which is the same as a thickness of the nanostructured layer.

20. The system of claim 16, further comprising a polarized light source and a polarization analyzer configured to receive light from the polarized light source by way of the optic to enable relative monitoring of the processing.
